(19) United States
(12) Patent Application Publication
(10) Pub. No.: US 2015/0032318 A1
(43) Pub. Date: Jan. 29, 2015

(54) DETERMINATION AND DISPLAY OF EXPECTED RANGE OF VEHICLE HAVING ELECTRIC TRACTION MOTOR

(71) Applicant: Magna E-Car Systems of America, Inc., Auburn Hills, MI (US)

(72) Inventor: Guangning Gao, Rochester Hills, MI (US)

(21) Appl. No.: 14/379,312

(22) PCT Filed: Feb. 14, 2013
(86) PCT No.: PCT/US13/26030

§ 371 Date: Aug. 18, 2014

Related U.S. Application Data
(60) Provisional application No. 61/601,387, filed on Feb. 21, 2012.

(51) Int. Cl. B60L 11/18; B60L 3/12

(52) U.S. Cl. CPC B60L 11/1862; B60L 3/12; Y10S 903/903
USPC 701/22; 180/65.275; 903/903

(57) ABSTRACT

A vehicle having at least an electric traction motor and a passenger cabin includes a controller. The controller has a memory storing an expected range routine and a processor coupled to the memory. The processor is configured to execute the expected range routine. An expected range for the vehicle is determined referencing an average power consumption of a cabin conditioning system over an selected duration of initial cabin conditioning. During the selected duration of initial cabin conditioning, the average power consumption of the cabin conditioning system is added to an instantaneous power consumption of at least the electric traction motor to determine a total power consumption of the vehicle. The total power consumption of the vehicle is used to determine the expected range, which is output on a display located in the passenger cabin for reference by the driver.

### CROSS-REFERENCE TO RELATED APPLICATIONS

This application claims the benefit of U.S. Provisional Patent Application No. 61/601,387 filed Feb. 21, 2012, which is incorporated herein by reference in its entirety.

### FIELD OF THE INVENTION

This disclosure relates to vehicles, and more particularly, vehicles having at least an electric traction motor.

### BACKGROUND OF THE INVENTION

This section provides background information related to the present disclosure which is not necessarily prior art.

The expected range of an electrically powered vehicle can be useful to a driver when determining whether a destination can be reached given the present level of charge of the vehicle. Inaccuracies in the expected range may misinform the driver of the true state of the vehicle. For example, when auxiliary systems of the vehicle are turned off or on, as is normally the case during a trip, the expected range can fluctuate. Given that expected range is usually a long-term prediction, such short-term fluctuations typically do not accurately reflect the true expected range of the vehicle, and thus can cause the driver to become confused or alarmed, which may result in a less-than-desirable experience with the vehicle.

In view of the above, it would be beneficial to provide technology that addresses and overcomes these issues so as to facilitate methods of determining the expected range of motor vehicles equipped with an electric traction motor.

### SUMMARY OF THE INVENTION

This section provides a general summary of the disclosure and is not a comprehensive disclosure of its full scope, aspects or features.

According to the present disclosure, a vehicle is provided having at least an electric traction motor and which has its expected range determined based on an average power consumption of a cabin conditioning system during times of varying power consumption by the cabin conditioning system. At other times, the expected range is determined based on actual power consumption of the cabin conditioning system.

According to one aspect of this disclosure, a method of determining an expected range of a vehicle having at least an electric traction motor and a passenger cabin is described. The method includes determining an average power consumption of a cabin conditioning system over a selected duration of initial cabin conditioning by the cabin conditioning system and, during the selected duration of initial cabin conditioning, adding the average power consumption of the cabin conditioning system to an instantaneous power consumption of at least the electric traction motor to determine a total power consumption of the vehicle. The method further includes using the total power consumption of the vehicle to determine the expected range of the vehicle, and displaying the expected range of the vehicle.

The method can further include determining the selected duration of the initial cabin conditioning by referencing an ambient temperature.

The method can further include determining the selected duration of initial cabin conditioning by referencing a setting of the cabin conditioning system. The setting of the cabin conditioning system can include a setting of an air duct blower. As an alternative, the setting of the cabin conditioning system can include a setting of an air duct door. As a further alternative, the setting can include a set temperature. The set temperature can include a heat exchanger set temperature of a heat exchanger of the cabin conditioning system. The set temperature can also include a heater set temperature of a heater of the cabin conditioning system.

The method can further include determining the selected duration of the initial cabin conditioning by referencing a cabin temperature.

The initial cabin conditioning can include cabin conditioning performed with changing power consumption of the cabin conditioning system.

The initial cabin conditioning can include cabin conditioning performed to reach steady-state power consumption of the cabin conditioning system.

The method can further include, after the selected duration of initial cabin conditioning, adding an instantaneous power consumption of the cabin conditioning system to the instantaneous power consumption of at least the electric traction motor to determine the total power consumption of the vehicle.

Determining the average power consumption for the cabin conditioning system can include referencing a predetermined power consumption profile of the cabin conditioning system.

According to another aspect of this disclosure, a method includes determining a selected duration of an initial cool-down or heat-up of a climate control system of a vehicle having an electric traction motor and, during the selected duration, calculating an expected range of the vehicle referencing an average power consumption of the climate control system during the initial cool-down or heat-up of the climate control system. The method further includes, after the selected duration, calculating the expected range of the vehicle referencing an actual power consumption of the climate control system to maintain operation of the climate control system, and displaying the expected range on a display located in a passenger cabin of the vehicle.

According to another aspect of this disclosure, a device for a vehicle having at least an electric traction motor and a passenger cabin is described. The device includes a memory storing an expected range routine and a processor coupled to the memory. The processor is configured to execute the expected range routine to determine an average power consumption of a cabin conditioning system over a selected duration of initial cabin conditioning by the cabin conditioning system and, during the selected duration of initial cabin conditioning, add the average power consumption of the cabin conditioning system to an instantaneous power consumption of at least the electric traction motor to determine a total power consumption of the vehicle. The processor is further configured to use the total power consumption of the vehicle to determine the expected range of the vehicle, and output the expected range of the vehicle to a display.

The processor can be further configured to determine the selected duration of cabin conditioning by referencing an ambient temperature. The processor can be further configured to determine the selected duration of initial cabin conditioning by referencing a setting of the cabin conditioning system. The setting of the cabin conditioning system can include a setting of an air duct blower. Alternatively, the setting of the cabin conditioning system can include a setting of an air duct door. Furthermore, the setting can include a set temperature. The set temperature can include a heat exchanger set temperature of a heat exchanger of the cabin conditioning system. The set temperature can include a heater set temperature of a heater of the cabin conditioning system.

The processor can be further configured to determine the selected duration of cabin conditioning by referencing a cabin temperature.

The initial cabin conditioning can include cabin conditioning performed with changing power consumption of the cabin conditioning system.

The initial cabin conditioning can include cabin conditioning performed to reach steady-state power consumption of the cabin conditioning system.

The processor can be further configured to, after the selected duration of initial cabin conditioning, add an instantaneous power consumption of the cabin conditioning system to the instantaneous power consumption of at least the electric traction motor to determine the total power consumption of the vehicle.

The processor configured to determine the average power consumption for the cabin conditioning system can include the processor being configured to reference a predetermined power consumption profile of the cabin conditioning system.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings illustrate, by way of example only, embodiments of the present disclosure.

FIG. 1 is a block diagram of a vehicle having a device for determining an expected range of the vehicle.

FIG. 2 is a block diagram showing a determination of the expected range.

FIG. 3 is a flowchart showing a determination of the expected range.

FIG. 4 is a graph of compressor power consumption and evaporator temperature versus time.

FIG. 5 is a graph of power consumption of the cabin conditioning system and the expected range of the vehicle versus time.

### DETAILED DESCRIPTION OF THE INVENTION

Example embodiments will now be described more fully with reference to the accompanying drawings.

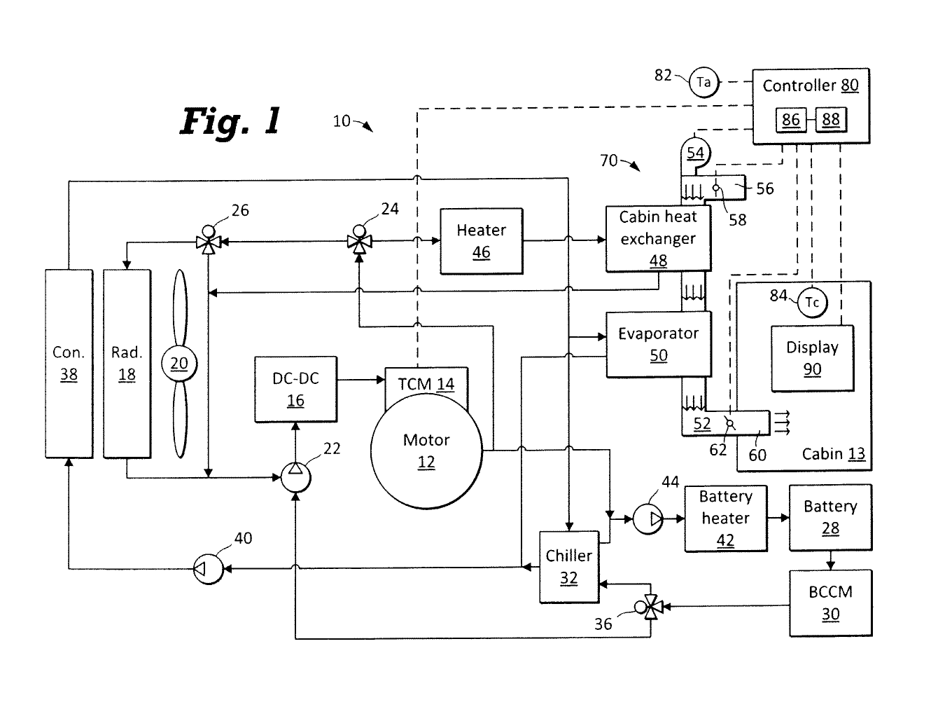

FIG. 1 shows a vehicle 10. The vehicle 10 includes an electric traction motor 12 used for driving the vehicle. The vehicle 10 may, for example, be a zero-emissions vehicle and may lack any non-electric drive means. Some components of the vehicle 10, such as the wheels and body, are omitted from FIG. 1 for the sake of clarity.

In addition to the electric traction motor 12, the vehicle 10 includes a transmission control module (TCM) 14, and a DC-DC converter 16, which are electrically connected to each other. It should be noted that, in FIG. 1, fluid connections are shown in solid line, while a select portion of electrical connections are shown in dashed line. Not all electrical and fluid connections are shown for the sake of clarity.

The electric motor 12 can be of any design capable of driving the vehicle 10. The motor 12 can be a high-voltage AC motor. The motor 12 may be mounted in a compartment forward of the passenger cabin 13 or at another location. The motor 12 includes at least one fluid conduit for flow of heat exchange fluid to cool the motor 12 since it generates heat. If the vehicle 10 is a hybrid vehicle it may further include an internal combustion engine.

The TCM 14 is mounted to the motor 12. The TCM 14 is part of the high-voltage electrical system of the vehicle 10 and is provided for controlling current flow to high-voltage electrical loads within the vehicle 10, such as the motor 12, an air-conditioning compressor, a heater, and the DC-DC converter 16. The TCM 14 generates heat during use and therefore includes at least one fluid conduit for flow of heat exchange fluid. In this example, the conduits of the TCM 14 and motor 12 are connected.

The DC-DC converter 16 receives current from the TCM 16 and converts it from high voltage to low voltage. The DC-DC converter 16 sends the low-voltage current to a low-voltage battery (not shown), which is used to power low-voltage loads in the vehicle 10. The low-voltage battery may operate on any suitable voltage, such as 12 volts or 48 volts. The DC-DC converter 16 is served by one or more conduits for flow of heat exchange fluid.

For purposes of cooling, the motor 12, TCM 14, and DC-DC converter 16 are arranged in a cooling loop, termed the motor loop, with a radiator 18, which can be positioned at the front of the vehicle 10 to receive air flow as the vehicle 10 moves. A fan 20 may be positioned near the radiator 18 to assist in moving air across the radiator 18. Conduits connect the DC-DC converter 16, TCM 14, motor 12, and radiator 18, with the direction of heat exchange fluid flow being in that listed order. A motor loop pump 22 is located between the radiator 18 and the DC-DC converter 16 to pump heat exchange fluid output from the radiator 18 into the DC-DC converter 16, and then through the TCM 14 and motor 12 before returning to the radiator 18 via a waste heat recovery valve 24 and a radiator bypass valve 26. The waste heat recovery valve 24 and the radiator bypass valve 26 can be electric diverter valves. The radiator bypass valve 26 can be controlled to cause heat exchange fluid to bypass the radiator 18 and return directly to the pump 22. Thermal control of the motor loop can be facilitated by one or more motor loop temperature sensors (not shown).

The vehicle 10 further includes at least one battery pack 28, a battery charge control module (BCCM) 30, a chiller 32, and a battery heater 34.

The battery pack 28 sends power to the TCM 14 for use by the motor 12 and other high-voltage loads, and thus forms part of the high-voltage electrical system. The battery pack 28 may be any suitable type of battery pack, such as one made up of a plurality of lithium polymer cells. The battery pack 28 has a temperature range in which it is preferably maintained, so as to provide it with a relatively long operating life. Accordingly, the battery pack 28 is provided with one or more heat exchange fluid conduits. While one battery pack 28 is shown, it is alternatively possible to have any suitable number of battery packs, such as two or more.

The BCCM 30 is configured to connect the vehicle 10 to an external electrical source (e.g., a 110-volt source or a 220-volt source) to provide current received from the electrical source to any of several destinations, such as, the battery pack 28. The BCCM 30 generates heat during use and thus can be provided with cooling. To this end, the BCCM 30 includes at least one fluid conduit for receiving heat exchange fluid, so as to maintain the BCCM 30 within a suitable temperature range.

The chiller 32 is connected to a fluid conduit downstream of the BCCM 30 after a battery loop valve 36, which can be an electric diverter valve. The chiller 32 can be any kind of heat exchanger. The chiller 32 receives refrigerant from a condenser 38, which is positioned near the radiator 18, and outputs refrigerant to a compressor 40, which is powered by the TCM 14 and provides refrigerant to the condenser 38. The chiller 32 may be operated according to a chiller set temperature. A thermal expansion valve (not shown) or electronic expansion valve (not shown) may be provided to control the chiller temperature. A flow control valve (not shown) may be provided to allow or prevent the flow of refrigerant to the chiller 32.

The battery heater 42 is positioned upstream of the battery pack 28 to provide heat to heat exchange fluid destined to the battery pack 28, should the battery pack 28 need to be heated. The battery heater 42 is an electrical heater that can be powered by the low-voltage battery. Heat exchange fluid is provided to the battery heater 42 from a battery loop pump 44, whose inlet is connected to the chiller 32.

For purposes of heating and cooling, the battery pack 28, BCCM 30, chiller 32, and battery heater 42 are arranged in a loop, termed the battery loop. Conduits connect the battery pack 28, BCCM 30, chiller 32, and battery heater 42, with the direction of heat exchange fluid flow being in that listed order. The battery loop pump 44 pumps heat exchange fluid through the battery heater 42, and then through the battery pack 28 and BCCM 30 before returning to the chiller 32 via the battery loop valve 36. The battery heater 42 may be used to heat heat exchange fluid in the battery loop. The chiller 32 may be used to cool heat exchange fluid in the battery loop. The battery loop can be selectably connected to the motor loop via the battery loop valve 36, in which case heat exchange fluid does not flow into the chiller 32 but instead enters the motor loop at the motor loop pump 22. Heat exchange fluid returns to the battery loop at a branch after exiting the motor 12. Thus, the battery loop valve 36 allows mixing of heat exchange fluid between the battery loop and the motor loop to allow, among other things, cooling of the heat exchange fluid from the battery loop via the radiator 18 instead of the chiller 32. Thermal control of the battery loop can be facilitated by one or more battery loop temperature sensors (not shown).

The vehicle 10 further includes a cabin heater 46, a cabin heat exchanger 48, and an evaporator 50.

The cabin heater 46 may be any suitable type of heater, such as an electric PTC heater that is a high-voltage electrical component powered by the TCM 14. The cabin heater 46 is selectably provided heat exchange fluid, which may have already been heated by the motor loop, via the waste heat recovery valve 24. If additional heat is to be provided to the cabin 13, the cabin heater 46 can heat the heat exchange fluid further.

The cabin heat exchanger 48 uses heat exchange fluid provided by the cabin heater 46 to heat air that is then provided to the cabin in order to heat the cabin. Heat exchange fluid exiting the cabin heat exchanger 48 returns to the motor loop pump 22 via the radiator bypass.

The evaporator 50 is a heat exchanger that uses refrigerant received from the condenser 38 to cool air that is then provided to the cabin in order to cool the cabin 13. Refrigerant exiting the evaporator 50 returns to the compressor 40. The evaporator 50 can be operated according to an evaporator set temperature. A thermal expansion valve (not shown) or electronic expansion valve (not shown) may be provided to control the evaporator temperature. The evaporator 50 can be provided with a flow control valve to allow or prevent flow of refrigerant to the evaporator 50. The flow control valve and expansion valve of the evaporator 50 can be controlled in conjunction with the like valves of the chiller 32 to control sharing of refrigerant between the evaporator 50 and chiller 32.

The vehicle 10 further includes cabin air ducting 52, which contains the cabin-air sides of the cabin heat exchanger 48 and the evaporator 50. Air is forced through the ducting 52 by a blower 54, which can be an electric blower powered by the low-voltage battery. The ducting 52 can include a return leg (not shown) to form a closed loop to recirculate conditioned cabin air. A fresh air inlet 56 can be provided to feed outside air into the ducting 52, as controlled by a controllably positionable air recirculation door 58. Conditioned air exits the ducting 52 at one or more cabin air outlets 60 as controlled by one or more air outlet doors 62. An additional air-diverting door (not shown) can be provided to control the proportions of air coming under the thermal influence of the cabin heat exchanger 48 and the evaporator 50.

A vehicle cabin conditioning system 70 includes the heater 46, cabin heat exchanger 48, evaporator 50, compressor 40, condenser 38, ducting 52, blower 54, and doors 58, 62. Due to thermal interrelations, other components of the vehicle 10 described above may be considered to form part of the cabin conditioning system 70, and the cabin conditioning system 70 may also include other components not shown. The cabin conditioning system 70 may be referred to as a heating, ventilation, and air conditioning (HVAC) system. A cabin heater portion of the cabin conditioning system 70 includes the heater 46, cabin heat exchanger 48, ducting 52, blower 54, and doors 58, 62, while an cabin air conditioning portion of the cabin conditioning system 70 includes the evaporator 50, compressor 40, condenser 38, ducting 52, blower 54, and doors 58, 62.

The above-described components of the vehicle 10 can be controlled by a controller 80 that will now be described with reference to techniques for determining an expected range of the vehicle 10. The controller 80 is a device that may be referred to as an engine control unit (ECU) or vehicle control unit (VCU). The portion of the controller 80 that performs an expected range determination may be referred to as a trip computer. A trip computer is a device that may be separate from the controller 80. The controller 80 is merely an example of a device that can perform the expected range determination for the vehicle 10.

The controller 80 includes a processor 86 and memory 88 coupled together. The processor 86 is capable of expecting instructions stored in the memory 88. The controller 80 further includes an input-output interface (not shown) for connecting to other components of the vehicle 10 to allow the processor 86 to communicate with such components. The input-output interface can include a controller-area network bus (CAN bus) or similar.

The controller 80 is electrically connected (dashed lines) to one or more components of the cabin conditioning system 70, such as the blower 54, the air recirculation door 58, or the air outlet door 62 in order to monitor settings of such components. Monitoring such settings can be achieved in many ways. For instance, monitoring a speed of the blower 54 may be achieved by monitoring the positioning of a dial that can be turned by the operator of the vehicle to increase or decrease air flow from the air outlets 60. Alternatively, if the blower 54 is controlled by the controller 80, monitoring the speed of the blower 54 can be achieved by monitoring the commanded speed. In another example, the blower 54 includes a transducer that directly measures speed or air flow and whose output is sent to the controller 80. Any of the components of the cabin conditioning system 70 can be monitored directly or indirectly by the controller 80 and may also be controlled by the controller 80.

The controller 80 is also electrically connected to other components of the vehicle 10 to monitor power consumption of the vehicle 10. For this purpose, in this example, the controller 80 is connected to the TCM 14, which distributes electrical power throughout the vehicle 10. In this way, the controller 80 can monitor electrical power consumed by each of the electrically powered components of the vehicle 10. In other examples, power consumed by a component of the vehicle 10 can be determined in other ways, such as by directly monitoring power consumption at the component. Irrespective of the specific method of monitoring, the controller 80 may have access to the instantaneous power usage (e.g., in watts) of each of the electrically powered components of the vehicle 10, or in some embodiments it may have access to the instantaneous power usage (e.g., in watts) of at least some of the electrically powered components of the vehicle 10.

The vehicle 10 further includes an ambient temperature sensor 82 and a cabin temperature sensor 84, each connected to the controller 80. The ambient temperature sensor 82 is positioned to measure a temperature indicative of the environmental temperature outside the vehicle 10. The cabin temperature sensor 84 is positioned to measure a temperature indicative of the temperature inside the passenger cabin 13. Each of the temperature sensors 82, 84 can include a thermocouple, a thermopile, a thermistor, or the like.

The vehicle 10 further includes a display 90, such as a liquid-crystal display (LCD) or light-emitting diode (LED) display situated in the cabin 13 and visible by the driver of the vehicle 10. The display 90 is connected to the controller 80 to output information relevant to operation of the vehicle 10.

The controller 80 is programmed to determine an expected range of the vehicle 10. An expected range can help the driver of the vehicle 10 plan his or her route, or determine whether or not the vehicle can complete a planned route. The expected range can be a distance-to-empty (DTE) range, which indicates the distance that can be driven before the vehicle 10, specifically the battery pack 28, will no longer have sufficient stored energy to continue driving. Alternatively, the expected range can be a distance that can be driven before the charge in the battery pack 28 drops to a selected minimum acceptable level, such as 20% of a full charge. Alternatively, the expected range can be another kind of range, such as a round-trip range that indicates how far the vehicle 10 can travel before it must be driven back to the origin of the trip so as to not run out of energy. In any case, the expected range is influenced by non-driving factors, such as the demands made on the cabin conditioning system 70. For example, the vehicle 10 may indicate an expected DTE range of 80 km, but when the air conditioning is turned on, the DTE range may be reduced to 78 km to account for energy expected to be consumed by the cabin conditioning system 70.

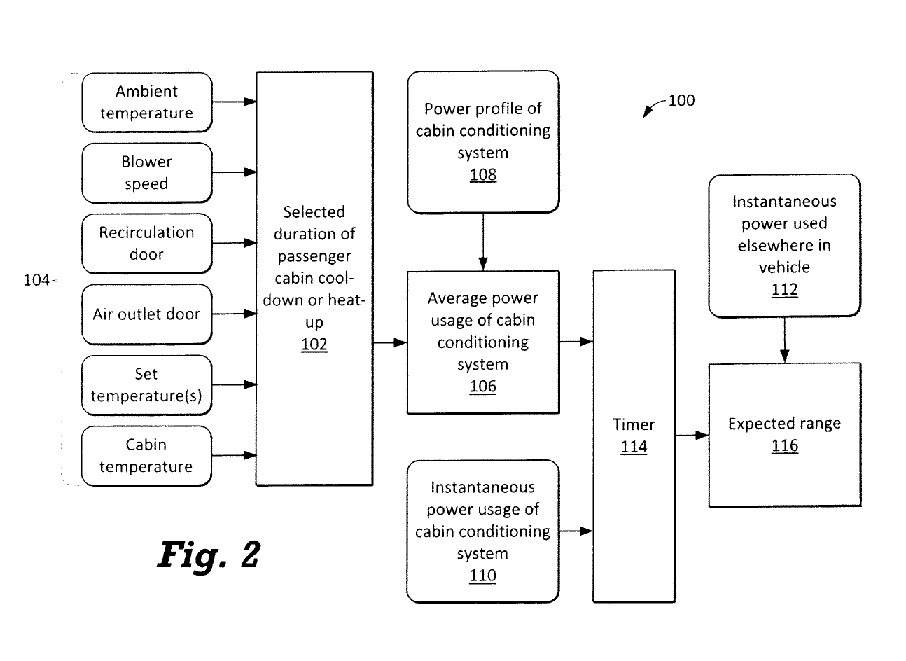

An example expected range routine 100 for the controller 80 is schematically illustrated in FIG. 2. The expected range routine 100 is stored in the memory 88 and includes instructions or other code that can be executed by the processor 86. The expected range routine 100 determines an expected range that does not confuse the driver of the vehicle 10 when a varying demand is placed on the cabin conditioning system 70.

At block 102, one or more factors 104 of the cabin conditioning system 70 can be used to determine a selected duration of initial cabin conditioning. The factors 104 that can be considered are those that significantly affect the time it takes to bring the cabin conditioning system 70 from a state of variable power consumption to steady-state operation in which power consumption of the cabin conditioning system 70 is relatively constant. That is, during initial cabin conditioning, power consumption of the cabin conditioning system 70 is not constant and may, for example, start high and decrease over time. The factors 104 can be used to determine the duration of changing cabin conditioning power consumption.

The cabin conditioning system 70 draws a variable amount of power as it undergoes a cool-down or heat-up process. For example, when the cabin conditioning system 70 is first started, its components may be at or near ambient temperature. Moreover, it may take time for components of the cabin conditioning system 70 to reach their normal operating states. Therefore, initially, a high amount of power may be provided to the cabin conditioning system 70 to quickly bring the cabin conditioning system 70 closer to its operating state, and such power may decrease over time as the cabin conditioning system 70 nears its operating state. For example, a cool-down of the cabin conditioning system 70 may require high power from the compressor 40 to bring the evaporator 50 to its set temperature, and such power may decrease as the evaporator 50 approaches its set temperature.

The factors 104 that can significantly affect the time it takes to bring the cabin conditioning system 70 from a state of variable power consumption to steady-state operation include one or more of the ambient temperature as measured by the ambient temperature sensor 82, a setting (such as speed or air flow) of the blower 54, a position of the air recirculation door 58, a position of the air outlet door 62, the cabin temperature as measured by the cabin temperature sensor 84, and one or more set temperatures. Set temperatures can include any one or more of a set temperature of the evaporator 50, the heater 46, the cabin heat exchanger 48, and the cabin 13. Any one or more of these factors can be referenced to determine the selected duration of initial cabin conditioning. For example, if the ambient temperature is very hot and the recirculation door is positioned to bring outside air into the cabin 13 through the evaporator 50 via the cabin air ducting 52, then it can be appreciated that it will take longer to bring the cabin conditioning system 70 to a state of steady power consumption than if the recirculation door is positioned to fully recirculate air inside the cabin 13. Although this is a qualitative example, the effects of the factors 104 on the selected duration of initial cabin conditioning can be quantified.

Quantified selected durations can be tabulated against the factors 104 in one or more lookup tables stored in the memory 88. In addition or alternatively, formulas can be used to correlate the selected duration to the factors 104. Thermodynamic principles, empirical principles, or test results can be referenced to construct a lookup table or formula. Additional factors that do not change can also be taken into account, such as the cabin volume and the thermal insulative characteristics of the cabin 13 and other parts of the vehicle 10.

In one example, the selected duration of initial cabin conditioning is a constant value, such as a time between 10 and 15 minutes.

Thus, block 102 determines how long it will take for the cabin conditioning system 70 to reach a state of relatively constant power consumption by for example, selecting a duration from a lookup table using the factors 104.

Block 106 determines an average power consumption of the cabin conditioning system 70 over the selected duration of initial cabin conditioning. This can be made by referencing a predetermined power consumption profile 108 for the cabin conditioning system 70. The power profile 108 can include one or more lookup tables or formulas that relate settings of the cabin conditioning system 70 to average power consumption of the cabin conditioning system 70. The power consumption profile 108 can include average power values for the compressor 40, the fan 20, the heater 46, and the blower 54, for example, depending on the settings of the cabin conditioning system 70 (e.g., heat up or cool down). The power profile 108 may include a single average value for cabin cooling and a single average value for cabin heating. The power profile 108 can be based on empirical data or test results.

Block 110 determines the instantaneous power consumption used by the cabin conditioning system 70 for its current setting. This is power actually consumed by the cabin conditioning system 70, as opposed to an average power.

Block 112 determines the instantaneous power consumption used by other components of the vehicle 10, and notably, by the electric traction motor 12. Such power consumption can also include power used by the headlights, an audio system, a navigation system, to name a few. In other words, block 112 determines the instantaneous power consumption used by substantially all electrical loads except the cabin conditioning system 70.

The TCM 14 can be referenced, as mentioned above, to determine the instantaneous power consumptions of blocks 110 and 112.

At block 114, a determination is made as to whether the selected duration has been exceeded or not. This determination can be made using a timer, for example, that has a running time that is compared to the selected duration. When the selected duration has not been exceeded, the cabin conditioning system 70 is still performing initial cabin conditioning, so block 114 outputs the average power consumption of the cabin conditioning system 70. Otherwise, block 114 outputs the actual instantaneous power consumption of the cabin conditioning system 70, as determined at block 110.

At block 116, the expected range of the vehicle is determined. During the selected duration of initial cabin conditioning, the average power consumption of the cabin conditioning system 70, from 106, is added to the instantaneous power consumption of the remaining components of the vehicle 10, from 112, to determine a total power consumption of the vehicle 10.

The total power consumption of the vehicle 10 is then used to determine the expected range, which is displayed to the driver on the display 90. By virtue of using the average power consumption, from 106, for the duration of variable output by the cabin conditioning system 70, the expected range does not drop sharply only to rise, possibly to a higher value, as the power consumed by the cabin conditioning system 70 diminishes. Rather, the expected range initially drops and then decreases gradually, which is less confusing to the driver.

After the selected duration of initial cabin conditioning as elapsed, i.e., the cabin conditioning system 70 only needs to maintain its current level of power consumption, the instantaneous power consumption of the cabin conditioning system 70, from 110, is added to the instantaneous power consumption of the remaining components of the vehicle 10, from 112, to determine the total power consumption of the vehicle 10 for purposes of determining the expected range. That is, when the cabin conditioning system 70 is no longer under a changing load, and is thus not consuming a changing amount of power that would cause a confusing expected range, the actual power consumption of the cabin conditioning system 70 is referenced, rather than the average, by block 116.

The expected range routine 100 can be executed periodically. In addition or alternatively, the expected range routine 100 can be executed based on a trigger, such as the selection of a new setting for the cabin conditioning system 70 or based on another determination by the controller 80 that a changing amount of power will be demanded by the cabin conditioning system 70.

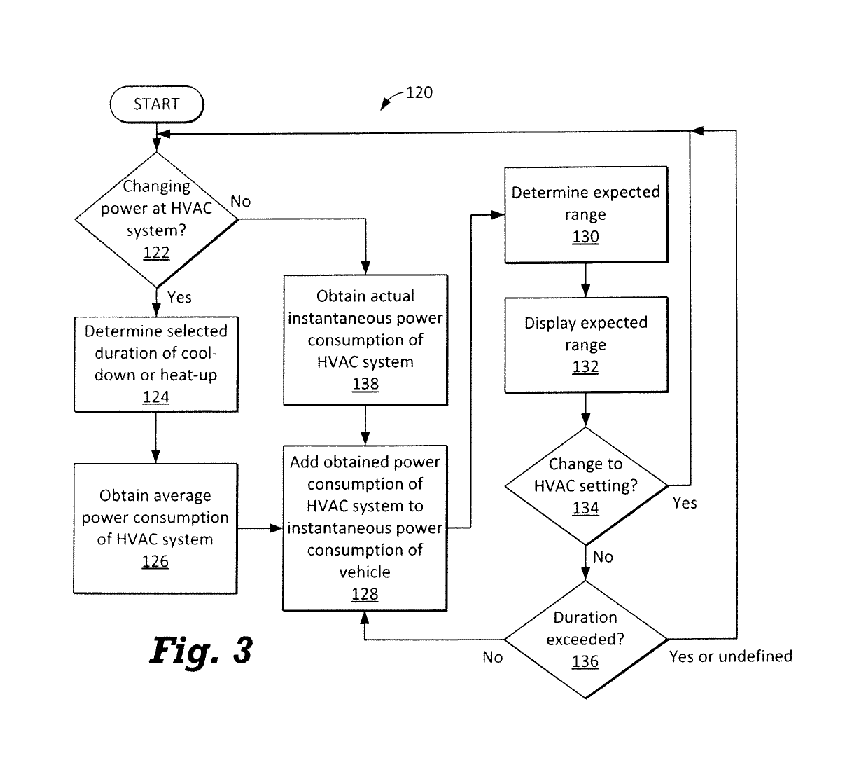

FIG. 3 illustrates a flowchart for a method 120 of determining an expected range. The method 120 can be used as a basis for the expected range routine 100 or another similar routine that can be executed by the processor 86.

At step 122, it is determined whether the cabin conditioning system 70 demands changing amount of electrical power. The level of electrical power can also be considered, as low powers, even those that are changing, may not significantly affect the expected range determination. A threshold for making this determination can be established and can be based on, for example, an initial amount of power being consumed by the cabin conditioning system 70 before the DTE calculation is performed. If the initial power is above a threshold, then a decreasing power draw is to be expected for the cabin conditioning system 70. In another example, the threshold can be based on a comparison of a set temperature with a measured temperature. For instance, if the set temperature for the evaporator 50 is exceeded by the ambient temperature by more than 20 degrees Celsius, then an initially high and changing power draw is determined to be expected for the cabin conditioning system 70. Thus, step 122 determines whether the cabin conditioning system 70 undergoes a changing power consumption, and can, optionally, determine whether the changing power consumption is high enough to warrant proceeding to step 124.

If the cabin conditioning system 70 is undergoing a changing power consumption, then the duration of the expected heat-up or cool-down is determined, at step 124. This determination can be based on the aforementioned factors 104 by, for example, referencing a lookup table.

Then, at step 126, the average power consumption of the cabin conditioning system 70 for the duration of initial cabin conditioning is obtained. This can include referencing a lookup table or formula, or simply selecting a value based on whether the cabin is being cooled or heated, as discussed above.

Next, at step 128, the average power consumption of the cabin conditioning system 70 is added to the instantaneous power consumption of the rest of the vehicle 10 including that of the motor 12.

The total instantaneous power consumption is then used to determine the expected range of the vehicle 10, at step 130. For example, if the total instantaneous power consumption is 5 kW and the battery pack 28 still stores 15 kWh of energy, then the vehicle 10 can be operated for an additional 3 hours (15 kWh/5 kW). The distance that can be travelled in this time can then be calculated using an average expected speed of the vehicle 10 using known techniques. Supposing the average expected speed is 50 km/h, then the expected range is determined to be 150 km (50 km/h*3 hours).

Then, at step 132, the determined expected range is displayed to the driver of the vehicle 10.

At step 134, the method 120 determines whether a setting of the cabin conditioning system 70 has been changed, as such a change may affect the selected duration and thus the expected range calculation. For example, the driver may change the position of the cabin air recirculation door 58. Moreover, the cabin conditioning system 70 may be turned off at any time, which again will affect the expected range. If a setting of the cabin conditioning system 70 has been changed, then the method 120 restarts.

If no setting has been changed, then a check is made as to whether the selected duration has elapsed, at step 136. When the selected duration has elapsed, then the method 120 restarts, with the expectation that the changing power draw of the cabin conditioning system 70 is completed and a relatively constant level of power is now being consumed, at least for purposes of determining the expected range. However, if the selected duration was not long enough, then a new selected duration will be obtained at step 124 upon the next evaluation of step 122. On the other hand, when the selected duration has not yet elapsed, the method returns to step 128 to perform the expected range determination again to take into account any change in the instantaneous power consumption of the vehicle 10 aside from the cabin conditioning system 70.

If the cabin conditioning system 70 is not under changing load, then the actual instantaneous power consumption of the cabin conditioning system 70 is referenced, at step 138, for the expected range determination of steps 128 through 132. In this case, the selected duration is not used (e.g., undefined) and the test at step 136 results in the method returning to step 122.

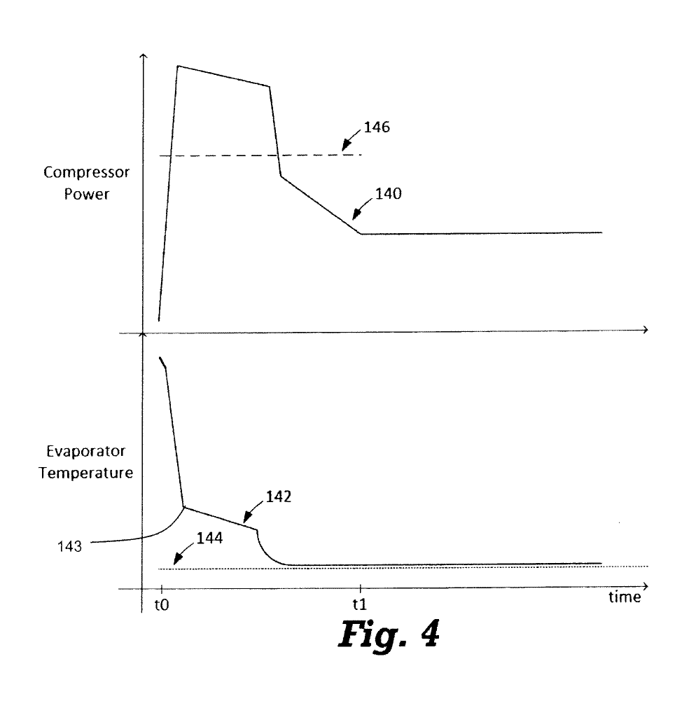

FIG. 4 shows a graph of power consumption for the compressor 40 and temperature of the evaporator 50 versus time, and is illustrative of a cool-down for the air conditioning portion of the cabin conditioning system 70.

The power consumption curve 140 varies with time from a time t0 when the air conditioning is turned on to a time t1. The duration from time t0 to time t1 is the duration of initial cabin conditioning. After t1, the power consumption curve 140 remains constant, as the cabin conditioning system 70 need only maintain a steady-state of operation to make up for losses. From time t0 to t1, it can also be seen that the evaporator temperature curve 142 decreases to the evaporator set temperature 144. It will be noted that the evaporator temperature drops relatively quickly during an initial period of time which is when the evaporator temperature is above the ambient temperature. For example, the evaporator may have an initial temperature of, for example, 40 degrees Celsius, and the ambient temperature may be, for example, 15 degrees Celsius. Once the evaporator temperature drops below the ambient temperature (at point 143 on the curve 142), it can be seen that the evaporator temperature drops more slowly even though it can be seen that the amount of power being consumed by the compressor (shown by curve 140) does not change significantly. The evaporator temperature 142 arrives at the set temperature 144 before the compressor power 140 is steady-state and this may be due to, for example, the cabin air temperature still being relatively high. An average power 146 of the compressor 40 can be used for expected determination before t1, and the actual instantaneous power of the compressor 40 can be used for expected range determination after t1. The duration from t0 to t1 can be stored in a lookup table, as described above.

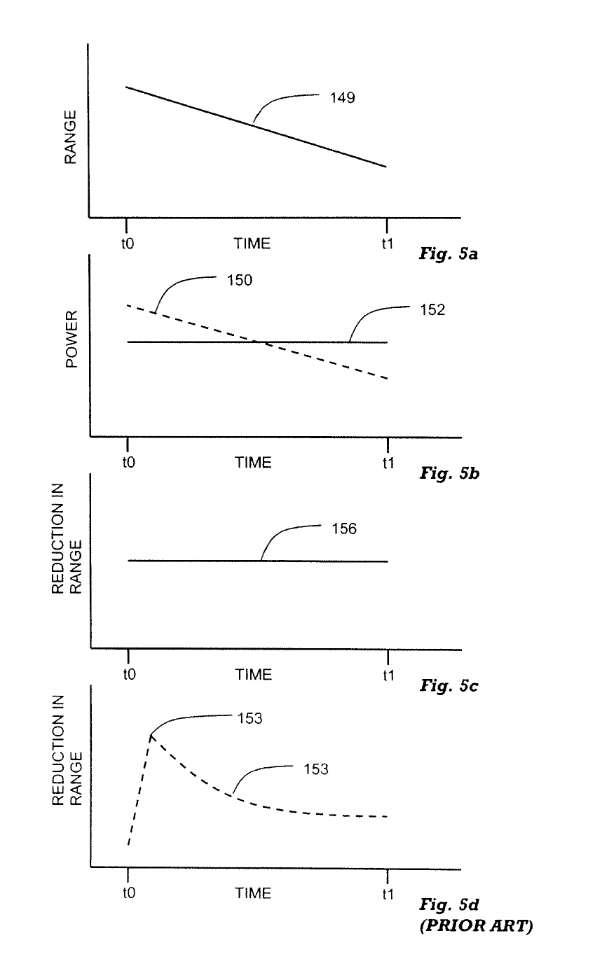

FIGS. 5a-5d show several curves related to power consumption and expected range versus time for a simplified example scenario of the above-described techniques for determining expected range.

FIG. 5a shows a curve 149 which shows how the vehicle range displayed to the driver drops linearly when driving the vehicle at constant speed on a road having a constant grade, and without operation of the air conditioning system. As can be seen, the vehicle range displayed to the driver drops linearly over time.

As noted above, however, when the cabin conditioning system is turned on, the power consumption of the compressor 40 rises to a particular value and then drops approximately linearly between time t0 and t1. The curve 150 in FIG. 5b represents the power consumption by the cabin conditioning system 70 between times t0 and t1. FIG. 5d shows a curve 153 that represents the reduction in the range that would be displayed to the driver when based on the power consumption curve 150 in FIG. 5b (and which is in accordance with the prior art). The impact of power consumption on the displayed range in a vehicle of the prior art may initially be small, as shown in FIG. 5d, because in some vehicles of the prior art the vehicle controller calculates the range of the vehicle based on an average of the power consumption over some selected time period (e.g. 10 seconds). Over time the calculated average power consumption would increase, as more and more time spent with the compressor on is accounted for in the average, and accordingly the impact on the displayed range would also increase. After reaching a peak shown at 154, the impact of the compressor operation on the displayed range would drop due to the progressively decreasing power consumption shown by curve 150. It will be understood that the changes in the curve 153 will result in changes in the rate at which the displayed range decreases. These changes in the rate of decrease in the displayed range may be quite disconcerting to the driver of the vehicle.

Referring to FIG. 5b again, by working with the expected average power consumption over the time period t0 to t1, the impact on the displayed range will be constant for that time period, as shown by curve 156 in FIG. 5c. This will be less disconcerting to the driver of the vehicle because the rate of decrease in the displayed range will remain more consistent over the time period t0 to t1 in spite of the changes in power consumption by the compressor during the time period t0 to t1.

Although this disclosure describes determining a selected duration of power consumption, the techniques describe herein may also reference energy consumption directly, since energy is power multiplied by duration (i.e., time). In other words, instantaneous power consumption of a cabin conditioning system over an selected duration is equivalent to expected energy consumption.

While the above-described refinement to an expected range or DTE calculation is particularly relevant for a vehicle having an electric traction motor and no internal combustion engine, it is possible to provide the above described refinement for a vehicle that has an internal combustion engine in addition to the electric traction motor. In embodiments wherein an internal combustion engine (not shown) is provided, it may be used as a means for generating electricity for driving the electric traction motor (i.e. a series hybrid), or it may be capable in some circumstances of driving the vehicle either alone or in addition to the electric traction motor.

According to one aspect of this disclosure, a method of determining an expected range of a vehicle having at least an electric traction motor and a passenger cabin is described. The method includes determining an average power consumption of a cabin conditioning system over a selected duration of initial cabin conditioning by the cabin conditioning system and, during the selected duration of initial cabin conditioning, adding the average power consumption of the cabin conditioning system to an instantaneous power consumption of at least the electric traction motor to determine a total power consumption of the vehicle. The method further includes using the total power consumption of the vehicle to determine the expected range of the vehicle, and displaying the expected range of the vehicle.

The method can further include determining the selected duration of cabin conditioning by referencing an ambient temperature.

The method can further include determining the selected duration of initial cabin conditioning by referencing a setting of the cabin conditioning system.

The setting of the cabin conditioning system can include a setting of an air duct blower.

The setting of the cabin conditioning system can include a setting of an air duct door.

The setting can include a set temperature.

The set temperature can include a heat exchanger set temperature of a heat exchanger of the cabin conditioning system.

The heat exchanger can include an evaporator.

The set temperature can include a heater set temperature of a heater of the cabin conditioning system.

The method can further include determining the selected duration of cabin conditioning by referencing a cabin temperature.

The initial cabin conditioning can include cabin conditioning system performed with changing power consumption of the cabin conditioning system.

The initial cabin conditioning can include cabin conditioning performed to reach steady-state power consumption of the cabin conditioning system.

The method can further include, after the selected duration of initial cabin conditioning, adding an instantaneous power consumption of the cabin conditioning system to the instantaneous power consumption of at least the electric traction motor to determine the total power consumption of the vehicle.

Determining the average power consumption for the cabin conditioning system can include referencing a predetermined power consumption profile of the cabin conditioning system.

The expected range is a distance-to-empty range.

According to another aspect of this disclosure, a method includes determining a selected duration of an initial cool-down or heat-up of a climate control system of a vehicle having an electric traction motor and, during the selected duration, calculating an expected range of the vehicle referencing an average power consumption of the climate control system during the initial cool-down or heat-up of the climate control system. The method further includes, after the selected duration, calculating the expected range of the vehicle referencing an actual power consumption of the climate control system to maintain operation of the climate control system, and displaying the expected range on a display located in a passenger cabin of the vehicle.

According to another aspect of this disclosure a device for a vehicle having at least an electric traction motor and a passenger cabin is described. The device includes a memory storing an expected range routine and a processor coupled to the memory. The processor is configured to execute the expected range routine to determine an average power consumption of a cabin conditioning system over a selected duration of initial cabin conditioning by the cabin conditioning system and, during the selected duration of initial cabin conditioning, add the average power consumption of the cabin conditioning system to an instantaneous power consumption of at least the electric traction motor to determine a total power consumption of the vehicle. The processor is further configured to use the total power consumption of the vehicle to determine the expected range of the vehicle, and output the expected range of the vehicle to a display.

The processor can be further configured to determine the selected duration of cabin conditioning by referencing an ambient temperature.

The processor can be further configured to determine the selected duration of initial cabin conditioning by referencing a setting of the cabin conditioning system.

The setting of the cabin conditioning system can include a setting of an air duct blower.

The setting of the cabin conditioning system can include a setting of an air duct door.

The setting can include a set temperature.

The set temperature can include a heat exchanger set temperature of a heat exchanger of the cabin conditioning system.

The heat exchanger can include an evaporator.

The set temperature can include a heater set temperature of a heater of the cabin conditioning system.

The processor can be further configured to determine the selected duration of cabin conditioning by referencing a cabin temperature.

The initial cabin conditioning can include cabin conditioning system performed with changing power consumption of the cabin conditioning system.

The initial cabin conditioning can include cabin conditioning performed to reach steady-state power consumption of the cabin conditioning system.

The processor can be further configured to, after the selected duration of initial cabin conditioning, add an instantaneous power consumption of the cabin conditioning system to the instantaneous power consumption of at least the electric traction motor to determine the total power consumption of the vehicle.

The processor configured to determine the average power consumption for the cabin conditioning system can include the processor being configured to reference a predetermined power consumption profile of the cabin conditioning system.

The expected range can be a distance-to-empty range.

While the foregoing provides certain non-limiting example embodiments, it should be understood that combinations, subsets, and variations of the foregoing are contemplated.

1. A method of determining an expected range of a vehicle having at least an electric traction motor and a passenger cabin, the method comprising:
determining an average power consumption of a cabin conditioning system over a selected duration of initial cabin conditioning by the cabin conditioning system;
during the selected duration of initial cabin conditioning, adding the average power consumption of the cabin conditioning system to an instantaneous power consumption of at least the electric traction motor to determine a total power consumption of the vehicle;
using the total power consumption of the vehicle to determine the expected range of the vehicle; and
displaying the expected range of the vehicle.

2. (canceled)

3. The method of claim 1, further comprising determining the selected duration of initial cabin conditioning by referencing a setting of the cabin conditioning system.

4. (canceled)

5. (canceled)

6. The method of claim 3, wherein the setting comprises a set temperature.

7. The method of claim 6, wherein the set temperature comprises a heat exchanger set temperature of a heat exchanger of the cabin conditioning system.

8. (canceled)

9. The method of claim 6, wherein the set temperature comprises a heater set temperature of a heater of the cabin conditioning system.

10. The method of claim 1, further comprising determining the selected duration of cabin conditioning by referencing one of an ambient temperature and a cabin temperature.

11. The method of claim 1, wherein the initial cabin conditioning comprises cabin conditioning performed with changing power consumption of the cabin conditioning system.

12. The method of claim 1, wherein the initial cabin conditioning comprises cabin conditioning performed to reach steady-state power consumption of the cabin conditioning system.

13. The method of claim 1, further comprising, after the selected duration of initial cabin conditioning, adding an instantaneous power consumption of the cabin conditioning system to the instantaneous power consumption of at least the electric traction motor to determine the total power consumption of the vehicle.

14. The method of claim 1, wherein determining the average power consumption for the cabin conditioning system comprises referencing a predetermined power consumption profile of the cabin conditioning system.

15. (canceled)

16. A method of determining a selected duration of an initial cool-down or heat-up of a climate control of a vehicle having an electric traction motor, the method comprising:
during the selected duration, calculating an expected range of the vehicle referencing an average power consumption of the climate control system during the initial cool-down or heat-up of the climate control system;
after the selected duration, calculating the expected range of the vehicle referencing an actual power consumption of the climate control system to maintain operation of the climate control system; and
displaying the expected range on a display located in a passenger cabin of the vehicle.

17. A device for a vehicle having at least an electric traction motor and a passenger cabin, the device comprising:
a memory storing an expected range routine; and
a processor coupled to the memory, the processor configured to execute the expected range routine to: determine an average power consumption of a cabin conditioning system over a selected duration of initial cabin conditioning by the cabin conditioning system; during the selected duration of initial cabin conditioning, add the average power consumption of the cabin conditioning system to an instantaneous power consumption of at least the electric traction motor to determine a total power consumption of the vehicle; use the total power consumption of the vehicle to determine the expected range of the vehicle; and output the expected range of the vehicle to a display.

18. (canceled)

19. The device of claim 17, wherein the processor is further configured to determine the selected duration of initial cabin conditioning by referencing a setting of the cabin conditioning system.

20. (canceled)

21. (canceled)

22. The device of claim 19, wherein the setting comprises a set temperature.

23. The device of claim 22, wherein the set temperature comprises a heat exchanger set temperature of a heat exchanger of the cabin conditioning system.

24. (canceled)

25. The device of claim 22, wherein the set temperature comprises a heater set temperature of a heater of the cabin conditioning system.

26. The device of claim 17, wherein the processor is further configured to determine the selected duration of cabin conditioning by referencing one of an ambient temperature and a cabin temperature.

27. The device of claim 17, wherein the initial cabin conditioning comprises cabin conditioning performed with changing power consumption of the cabin conditioning system.

28. The device of claim 17, wherein the initial cabin conditioning comprises cabin conditioning performed to reach steady-state power consumption of the cabin conditioning system.

29. The device of claim 17, wherein the processor is further configured to, after the selected duration of initial cabin conditioning, add an instantaneous power consumption of the cabin conditioning system to the instantaneous power consumption of at least the electric traction motor to determine the total power consumption of the vehicle.

30. (canceled)

31. (canceled)
